(19) United States
(12) Patent Application Publication
(10) Pub. No.: US 2010/0257467 A1
(43) Pub. Date: Oct. 7, 2010

(54) REAL-TIME INSTRUCTION DEVICE

(75) Inventors: Chia-Lin Lu, Kaohsiung City (TW); Ya-Pei Chen, Kaohsiung City (TW); Tzu-Yin Lu, Kaohsiung City (TW); Shu-Ching Wang, Kaohsiung City (TW); Ho-Yun Shih, Kaohsiung City (TW); Huei-Chuan Cho, Kaohsiung City (TW); Ching-Yi Chen, Kaohsiung City (TW); Hsueh-Ping Yu, Kaohsiung City (TW); Tzu-Hui Wu, Kaohsiung City (TW); Ping-Kuang Tsai, Kaohsiung City (TW); Yi-Chuan Fang, Kaohsiung City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Bais Education & Technology Co., Ltd., Kaohsiung City (TW)

(21) Appl. No.: 12/631,472

(22) Filed: Dec. 4, 2009

(30) Foreign Application Priority Data
Apr. 3, 2009 (TW) 098111189

(51) Int. Cl. G06F 3/048; G06F 3/01

(52) U.S. Cl. 715/760; 715/769; 715/765; 715/777

(57) ABSTRACT

A real-time instruction device in accordance with the present invention comprises a database, a selecting module and a GUI. The database comprises at least multiple classifications and multiple Flash components corresponding to the classifications. The selecting interface allows a teacher to select a classification from the database. The GUI virtually simulates a white board that allows the teacher to dynamically drag a selected Flash component for real-time instruction with boundless space for teaching.

### FIELD OF THE INVENTION

The present invention is a device that provides teachers a real-time capability to select dynamic teaching materials through a graphical user interface (GUI).

### BACKGROUND OF THE INVENTION

In recent years, educational instruction techniques have evolved greatly from classical classroom teaching techniques. Classical classroom teaching techniques comprise a teacher presenting information to students in textbooks and lectures and using a white board to emphasize specific points.

Moreover, many subjects such as geometry and science often require teachers to prepare teaching devices (such as geometric models) or draw a specific diagram (such as a perspective view of a pyramid) on the white board to assist in explaining cogent principles to students. Drawing diagrams in class is time consuming and preparing a model before class is time consuming and may be expensive.

To accommodate student and teacher time and location constraints, remote study and electronic learning (e-learning) have become desirable options for education. Faster computers and networks such as the Internet and local area networks (LANs) have made this possible.

However, digitalizing written materials to accommodate e-learning may require extensive reproduction work such as cutting, copying, typing and scanning. Therefore, efficient methods of reproducing and digitalizing printed material are required.

Further, digitalization of teaching material is generally prepared in advance by professional specialists (i.e. professional Flash animators), and most teachers are not sufficiently trained as animators. Consequently, significant discussion is often required between the animator and the teacher to obtain enough digitalized teaching materials to adequately support instruction.

### SUMMARY OF THE INVENTION

The primary objective is to provide a device to support instruction in real-time and provides teachers a capability to select dynamic teaching materials quickly through a graphical user interface (GUI).

The secondary objective is to provide a real-time instruction device that provides teachers extensive teaching resources by modularizing teaching materials into Flash components.

The real-time instruction device in accordance with the present invention comprises a database, a selecting module and a GUI. The database comprises multiple classifications and multiple Flash components corresponding to the classifications. The selecting interface allows a teacher to select a classification from the database. The GUI simulates a white board on a monitor that allows the teacher to dynamically drag a selected Flash component in real-time to support instruction with unlimited space for teaching.

### BRIEF DESCRIPTIONS OF THE DRAWINGS

FIG. 1 is a diagram of a graphical user interface in accordance with present invention.

### DETAILED DESCRIPTION OF THE PRESENT INVENTION

The real-time instruction device in accordance with the present invention comprises a database, a selecting interface and a graphical user interface (GUI).

The database comprises multiple records, multiple classifications and multiple Flash components. The classifications are stored respectively in the records about a specific teaching subject and may be an eXtensible Markup Language (XML) file format. The Flash components correspond to the classification and may be either static or dynamic images (such as animations). The static and dynamic Flash component images can be two dimensional (2D) or three dimensional (3D).

The 3D Flash components are made first by 3D illustrator software (such as Autodesk (Registered Trademark (RTM)) 3D Studio MAX, Maya or Blender) and saved as a COLLAborative Design Activity (COLLADA) extension file format, (.dae). The .dae file is then converted to a Flash component.

The selecting interface is connected to the database and allows a teacher to select a classification from the database.

The GUI is connected to the database and the selecting interface, retrieves Flash components based on a classification selected by the teacher and may be a web-based interface that is controllable by an external input device such as a mouse or a touch panel device.

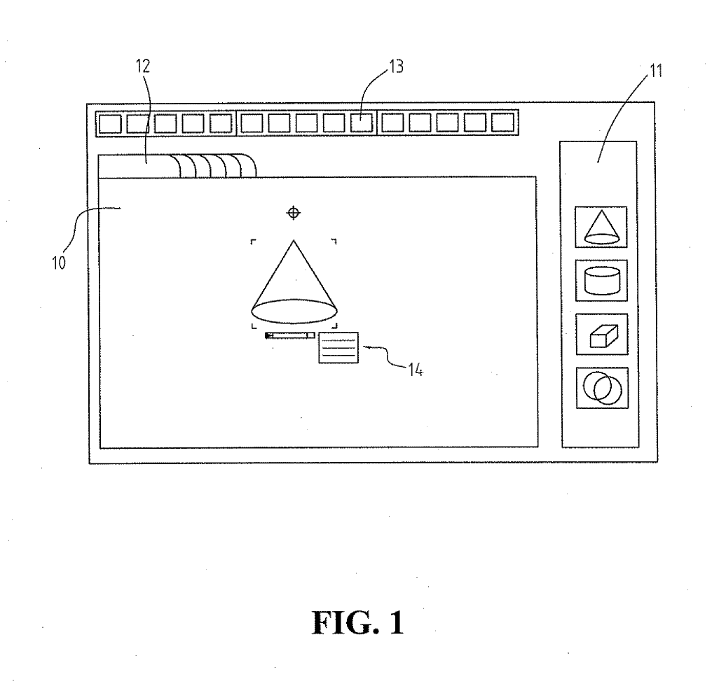

With reference to FIG. 1, the GUI comprises a selection menu (11), an operating area (10), at least one selection tab (12) and control panel.

The selection menu (11) lists Flash components retrieved from the database.

The operating area (10) simulates a white board on a display (such as a computer monitor), is a “What You See Is What You Get” (WYSIWYG) area that allows the teacher to drag selected Flash components to desired locations from the selection menu (11).

The selection tabs (12) allow the teacher to switch tabs when more space is needed in the operating area (10) and the Flash components in the operating area (10) change based on the current selection tab (12) or correspond to another classification.

The control panel controls Flash components in the operating area (10) and may comprise multiple control options (13) and multiple character options (14).

The control options (13) are connected to the operating area (10) and may comprise sizing zooming, appearance adjusting, save and print. Appearance adjusting comprises color change, chroma change and brightness change.

The character options (14) allow the teacher to change characters associated with a dragged Flash component, are displayed in the operating area (10) next to the dragged Flash component and may comprise functions of paint, reveal, zoom, move, delete, rotate, animation control, mathematical function control, 3-dimensional (3D) rotate and lock.

The paint function allows the teacher to color a dragged Flash component a specific color in the operating area.

The reveal function allows the teacher to reveal internal components of a dragged Flash component.

The zoom function allows the teacher to zoom in or out individually on a dragged Flash component.

The move function allows the teacher to change positions of a dragged Flash component.

The delete function allows the teacher to remove a dragged Flash component from the operating area.

The rotate function allows the teacher to rotate a dragged Flash component in a 2-dimensional space.

The animation control function allows the teacher to control a dragged Flash component when the dragged Flash component is an animation.

The mathematical function allows the teacher to edit a dragged Flash component when the dragged Flash component is a mathematical function. For example, a dragged Flash component may be a second order polynomial, and the teacher can change values in the second order polynomial.

The 3D rotate function allows the teacher to rotate a dragged Flash component in a 3D space.

The lock function allows the teacher to lock a dragged Flash component so it cannot be deleted or changed unintentionally.

Therefore, the real-time instruction device in accordance with the present invention provides a teacher a capability to select dynamic teaching materials and place them in the operating area that simulates a conventional white board with a boundless space on a display.

People skilled in the art will understand that various changes, modifications, and alterations in form and details may be made without departing from the spirit and scope of the invention.

What is claimed is

1. A real-time instruction device comprising
a database comprising
multiple records;
multiple classifications being stored respectively in the records about a specific teaching subject; and
multiple Flash components corresponding to the classification;
a selecting interface being connected to the database and allowing a teacher to select a classification from the database; and
a graphical user interface (GUI) being connected to the database and the selecting interface, retrieving Flash components based on a selected classification of the teacher and comprising
a selection menu listing retrieved Flash components from the database;
an operating area being a “What You See Is What You Get” (WYSIWYG) area that allows a teacher to drag selected Flash components respectively to desired locations from the selective menu;
at least one selection tab allowing the teacher to switch tabs when the teacher needs more space in the operating area and the Flash components in the operating area change based on current tab; and
a control panel being connected to the operating area and controlling Flash components in the operating area.

2. The real-time instruction device as claimed in claim 1, wherein the Flash components are static or dynamic images.

3. The real-time instruction device as claimed in claim 1, wherein the GUI is a web-based interface.

4. The real-time instruction device as claimed in claim 1, wherein the selection tabs correspond to another classification.

5. The real-time instruction device as claimed in claim 1, wherein the control panel comprises
multiple control options comprise sizing zooming, appearance adjusting, save and print; and
multiple character options allow the teacher changes characters of a dragged Flash component directly, which dynamic showing next to the dragged Flash component.

6. The real-time instruction device as claimed in claim 2, wherein the static and dynamic Flash component images are two dimensional (2D) or three dimensional (3D).

7. The real-time instruction device as claimed in claim 5, wherein appearance adjusting comprises color change, chroma change and brightness change.

8. The real-time instruction device as claimed in claim 5, wherein character options further comprise paint, reveal, zoom, move, delete, rotate, animation control, mathematical function control, 3-dimensional (3D) rotation and lock functions.

9. The real-time instruction device as claimed in claim 8, wherein the paint function allows the teacher to color a dragged Flash component a specific color in the operating area.

10. The real-time instruction device as claimed in claim 8, wherein the reveal function allows the teacher to reveal internal components of a dragged Flash component.

11. The real-time instruction device as claimed in claim 8, wherein the zoom function allows a teacher to zoom a dragged Flash component in or out.

12. The real-time instruction device as claimed in claim 8, wherein the move function allows a teacher to change a dragged Flash component's position in the operating area.

13. The real-time instruction device as claimed in claim 8, wherein the delete function allows a teacher to remove a dragged Flash component from the operating area.

14. The real-time instruction device as claimed in claim 8, wherein the rotate function allows a teacher to rotate a dragged Flash component in a 2-dimensional space.

15. The real-time instruction device as claimed in claim 8, wherein the animation control function allows a teacher to control animation of a dragged animated Flash component.

16. The real-time instruction device as claimed in claim 8, wherein the mathematical function control function allows a teacher to edit a dragged Flash component when the dragged Flash component is a mathematical function.

17. The real-time instruction device as claimed in claim 8, wherein the 3D rotation function allows a teacher to rotate a dragged Flash component in a 3D space.

18. The real-time instruction device as claimed in claim 8, wherein the lock function allows a teacher to lock a dragged Flash component.

19. The real-time instruction device as claimed in claim 1, wherein the classification is an eXtensible Markup Language file format.
